(19) United States
(12) Patent Application Publication
(10) Pub. No.: US 2007/0126406 A1
(43) Pub. Date: Jun. 7, 2007

(54) Turbine with Configurable Generator Circuit

(75) Inventor: Larry H. Frew, Oceanside, CA (US)

Correspondence Address: SHELDON MAK ROSE & ANDERSON PC, 225 SOUTH LAKE AVENUE, 9TH FLOOR, PASADENA, CA, 91101, US

(73) Assignee: Prevailing Energy, Inc., Oceanside, CA (US)

(21) Appl. No.: 11/469,297

(22) Filed: Aug. 31, 2006

Related U.S. Application Data
(60) Provisional application No. 60/713,288, filed on Aug. 31, 2005.

(51) Int. Cl. H02P 9/00; H02H 7/06; H02P 11/00

(52) U.S. Cl. 322/29

(57) ABSTRACT

A device for generating electricity including a turbine capable of spinning at variable revolutions per minute (RPM), an electric generator circuit configurable to either a Wye-type generator circuit or a Delta-type generator circuit connected to the turbine, and a switching circuit connected to the generator circuit to configure the generator circuit as a function of the turbine RPM.

### CROSS-REFERENCE TO RELATED APPLICATIONS

The present Application claims the benefit of U.S. Provisional Patent Application No. 60/713,288, entitled “Vertical Axis Turbine Generator Circuit”, filed Aug. 31, 2005, the context of which is expressly incorporated by reference herein.

### BACKGROUND

The invention pertains to the field of power generation devices, and more specifically to circuits for improving the efficiency of wind or water vertical turbine power generators.

There are numerous devices and methods for converting wind or water movement into electricity for consumer and industrial use. Among these devices are wind turbine generators and water turbine generators that convert wind movement or water movement, respectively, into electricity. Wind and water generators are generally divided into horizontal axis turbines and vertical axis turbines.

Horizontal axis turbines have two or three blade “airplane” type propellers that activate a generator through gears and pulleys. Advantageously, horizontal axis turbines are relatively inexpensive to manufacture to convert wind movement into electricity and do not have to be modified for converting water movement into electricity. Disadvantageously, however, horizontal axis turbines are excessively noisy, operate at only moderate wind speeds, use a single type of generator, require costly maintenance, must face the oncoming wind, must be placed at least about 150 feet above the ground, and require lubricants that are environmentally polluting. Further disadvantageously, the blades of horizontal axis turbines kill birds and bats.

Vertical axis turbines, by comparison, are more efficient because they have more turbine blades; they are mechanically simpler, smaller and are directly connected to the generator. Further, vertical axis turbines are self starting, quiet, and operate at all wind speeds. Disadvantageously, however, vertical axis turbines are not efficient at low wind speeds or water speed, use a single type of generator and a vertical axis turbine that is configured to convert wind movement into electricity, and must be modified for converting water movement into electricity.

Both horizontal and vertical turbines in the prior art use either a Wye-type generator or a Delta-type generator to maximize the generation of electricity from the water movement or wind movement. Turbines using the Wye-type generator can supply about 1.8 times as much voltage as the Delta-type generator where the wind speeds and water speeds are below about 9.5 km per hour. The Delta-type generator can supply about 1.8 times the current as the Wye-type generator configuration where the wind speeds and water speeds are above about 9.5 km per hour.

Therefore, there exists a need for a circuit that can switch between a Wye-type generator or a Delta-type generator as a function of the turbine speed to maximize the efficiency for converting wind movement or water movement.

### SUMMARY

The present invention meets this need by providing, a turbine capable of spinning at variable revolutions per minute (RPM), a configurable electric generator circuit connected to the turbine, and a switching circuit connected to the generator circuit to configure the generator circuit as a function of the turbine RPM. In a preferred embodiment, the circuit can be configured to either a Wye-type generator circuit or a Delta-type generator circuit. Optionally, the electric generator circuit and the switching circuit can be placed on a single printed circuit board. In a preferred embodiment, the switching circuit configures the generator circuit to a Wye-type generator when the turbine is placed in a wind or water stream with a speed less than about 9.5 Km per hour and to a Delta-type generator when the speed is above about 9.5 Km per hour. In a preferred embodiment, the switching circuit has a state controller circuit and a sense circuit, and the state controller circuit comprises one or more switches and determines the turbine RPM. The sense circuit can utilize voltage regulated gates, and the state controller circuit can use break-before-make field effect transistors.

### BRIEF DESCRIPTION OF THE DRAWINGS

These and other features, aspects and advantages of the present invention will become better understood with regard to the following description, appended claims, and accompanying figure where:

FIG. 1 is a schematic diagram of a switching circuit according to one embodiment of the present invention;

FIG. 2 is a diagram of a cage assembly for mounting vertical turbine blades usable in one embodiment of the present invention;

FIG. 3A is a cross sectional view of a rotor/generator assembly usable in one embodiment of the present invention;

FIG. 3B is an expanded view of the rotor assembly and the generator assembly usable in one embodiment of the present invention; and

FIG. 4 is a bottom view of a rotor plate usable in one embodiment of the present invention.

FIG. 5 is a block diagram of one embodiment of the invention, using the switching circuit of FIG. 1.

### DETAILED DESCRIPTION

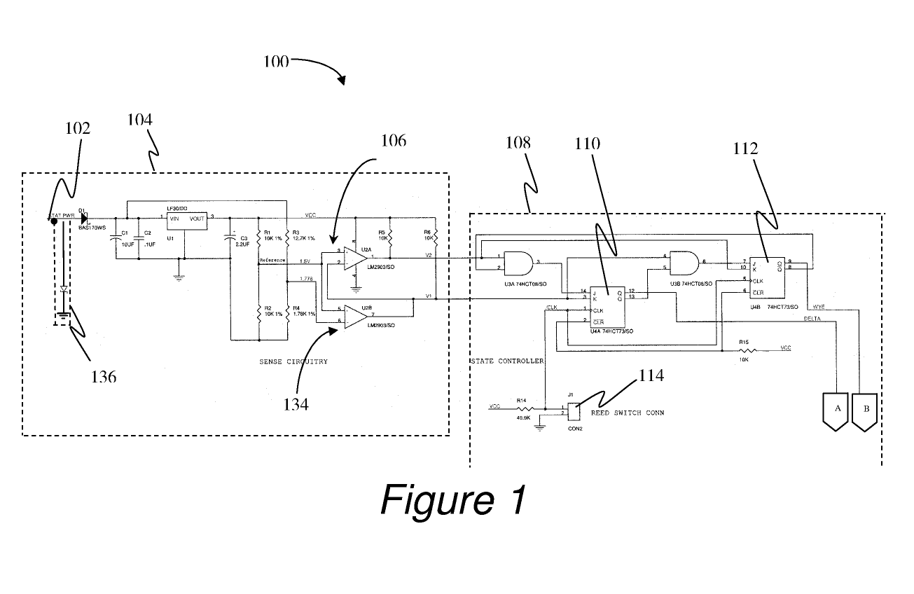

With reference to FIG. 1, there is shown a schematic diagram of a switching circuit 100 connected to a generator circuit 126 to configure the generator circuit 126, as a function of the turbine RPM. As can be seen the switching circuit 100 comprises a state controller circuit 108 and sense circuit 104 electrically connected to the state controller circuit.

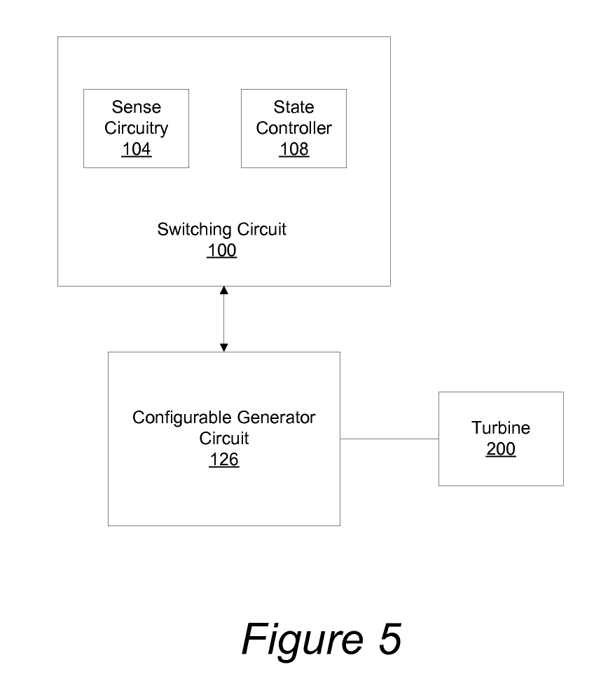

In the embodiment shown in FIG. 1 and FIG. 5, the configurable electric generator circuit 126 comprises three separate electrical phase coils 128, 130 and 132, each generating a separate electrical phase. The coils can be on three separate layers, or on a single board. In another embodiment (not shown), the configurable electric generator circuit 126 comprises three separate configurable electric generator circuits 126 on three separate printed circuit boards. In a preferred embodiment, the separate electrical phase coils 128-132 are constructed with wire wound in coils. In a particularly preferred embodiment, the wire is 15 AWG wire, though the wire can be any suitable gauge as will be understood by those with skill in the art with reference to this disclosure. In another preferred embodiment, the number of coils is between about 21 and 42. In a particularly preferred embodiment, the number of coil turns is 33. In another preferred embodiment, the measure of the coil turns is between about 10 and 20 cm. In a particularly preferred embodiment, the turns measure 15 cm. In another preferred embodiment, the separate electrical phase coils comprise an air core between about 0.5 and 1.5 cm thick. In a particularly preferred embodiment, the separate electrical phase coils have an air core 0.9525 cm thick. The number of coil turns, gauge of the wire, the measure of the coil turns and the air core, however, vary with the size of the vertical axis turbine constructed, as will be understood by those with skill in the art with reference to this disclosure.

In one embodiment, the state controller circuit 108 comprises one or more switches 116, 118, 120, 122, and 124 to configure the generator to a Wye-type generator or to a Delta-type generator to maximize the generation of electricity from the water movement or wind movement. In the embodiment shown in FIG. 1, the state controller circuit 108 further comprises two J-K flip-flop integrated circuits 110 and 112 and a Reed switch 114 for timing the switching circuit 100. The two J-K flip-flop integrated circuits 110 and 112 send control signals to the one or more switches 116-124 to configure the configurable electric generator circuit 126. The Reed switch 114 provides a clock signal for the state controller circuit 108 to time the switching circuit 100 and prevent the J-K flip-flop integrated circuits 110 and 112 from “chattering.” In a preferred embodiment, the one or more switches 116-122 are break-before-make Field Effect Transistors. In another preferred embodiment, the state controller circuit 108 initially configures the configurable electric generator circuit 126 as a Wye-type generator to supply a maximum voltage when placed in a wind or water stream with low speeds, such as for example wind speeds below about 9.5 km per hour. The state controller circuit 108 activates the one or more switches 116-124 to configure the configurable electric generator circuit 126 as a Delta-type generator to supply a maximum current when the turbine is in a wind or water stream with high speeds, for example, a wind speed above about 9.5 km per hour.

The sense circuit 104 is electrically connected to the state controller circuit and the generator circuit. The sense circuit 104 determines the turbine RPM and sends a signal to the state controller circuit 108. Voltage regulated gates 106 and 134 in the sense circuit 104 monitor a generator output voltage 102 from the configurable generator circuit 126. In a preferred embodiment, the sense circuit 104 transmits the signal to the state control circuit 108 only when the generator output voltage 102 is above 28V. Optionally, a voltage limiting zener shunt circuit 136 can be added to the sense circuit 104 to prevent the generator output voltage 102 from damaging the switching circuit 100. As will be evident, the turbine RPM can be easily converted to a wind or water stream speed, and the results programmed into the device so as to switch the generator circuit as a function of wind or water stream speed, i.e., turbine RPM.

In another embodiment (not shown), the sense circuit 104 is used with a storage battery to provide power to the circuit 100. In another embodiment, the storage battery acts as a storage medium charge controller. A voltage sensitive circuit isolates the storage battery with a solid state switch. The solid state switch turns the storage medium charge controller on and off between about 0.5 seconds and 30 seconds. When the storage battery is fully charged the device will provide a minimum electric load to the storage battery.

According to another embodiment of the present invention, there is provided a method for converting movement into electricity. In one embodiment, the method comprises, first, providing a multi-speed turbine. Then, providing a configurable electric generation circuit. Next, configuring the generator circuit as a function of the turbine speed.

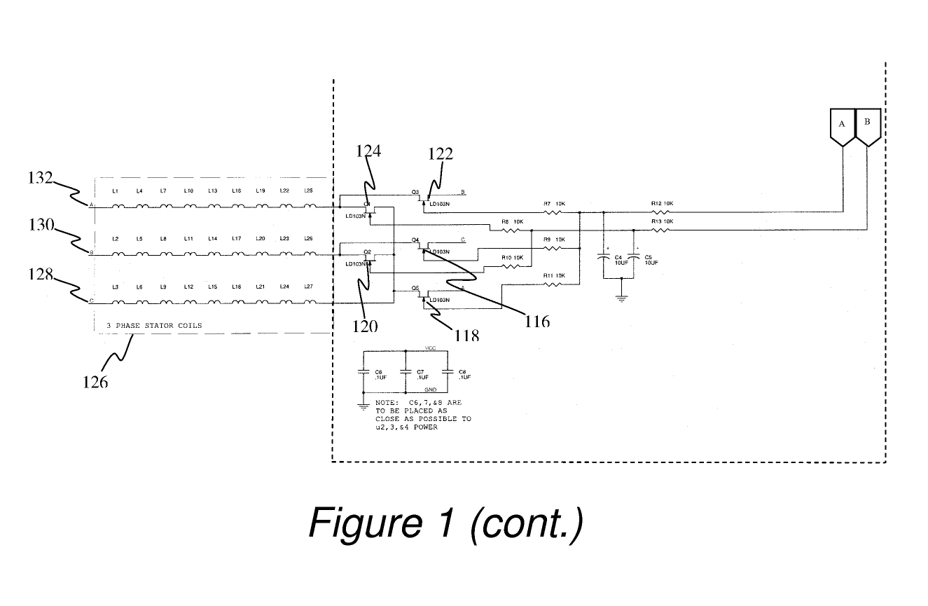

Referring now to FIG. 2, there is shown a diagram of a cage assembly 200 for mounting vertical turbine blades usable in one embodiment of the present invention. In one embodiment, the cage assembly 200 comprises one or more turbine blades 204. The one or more turbine blades 204 are held in place by a top support plate 202 and a bottom support mounting plate 206. In a preferred embodiment, the number of turbine blades 204 is an odd number.

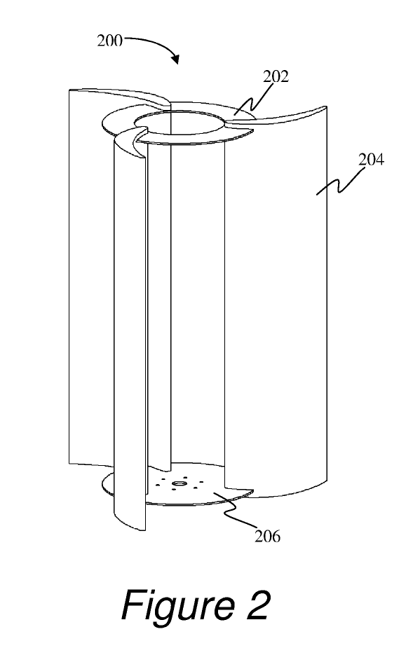

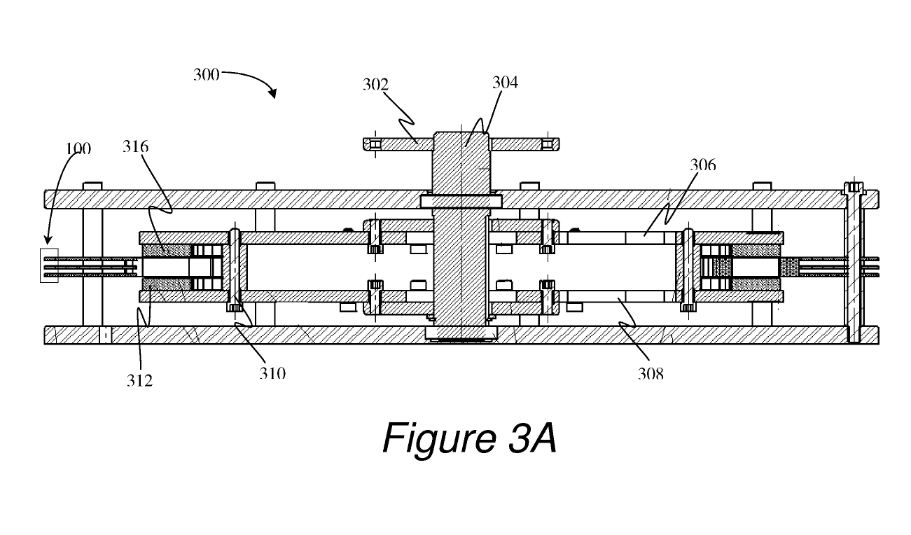

Referring now to FIG. 3A, there is shown a cross sectional view of a rotor/generator assembly usable in one embodiment of the present invention, and suitable for allowing the turbine to spin at variable RPM. In one embodiment, the turbine's bottom support mounting plate 206 is attached to a cage mounting plate 302. The cage mounting plate 302 is attached to a center shaft 304 that turns when wind or water strikes the turbine blades. One or more rotor plates 306 and 308 are attached to the center shaft 304 to spin one or more magnets attached to the outer edge of the one or more rotor plates. A shunt ring 310 magnetically connects the one or more magnets 312 and 316. One or more switching circuits 100 are electrically connected to the one or more rotor plates for generating electricity.

Referring now to FIG. 3B, there is shown an expanded view of the rotor assembly and the generator assembly usable in one embodiment of the present invention. As can been seen, the wire wound coils 318 of the rotor/generator assembly 300 pass between the magnets 312 and 316 to generate electricity. The shunt 310 allows the magnetic field to flow from a positive pole of magnet 312 to a negative pole of magnet 316 to produce a strong magnetic field. In another embodiment a horseshoe magnet (not shown) replaces magnets 312 and 316, and shunt 310. The one or more switching circuits 100 configure the configurable electric generator circuit 126 to either a Wye-type generator or to a Delta-type generator.

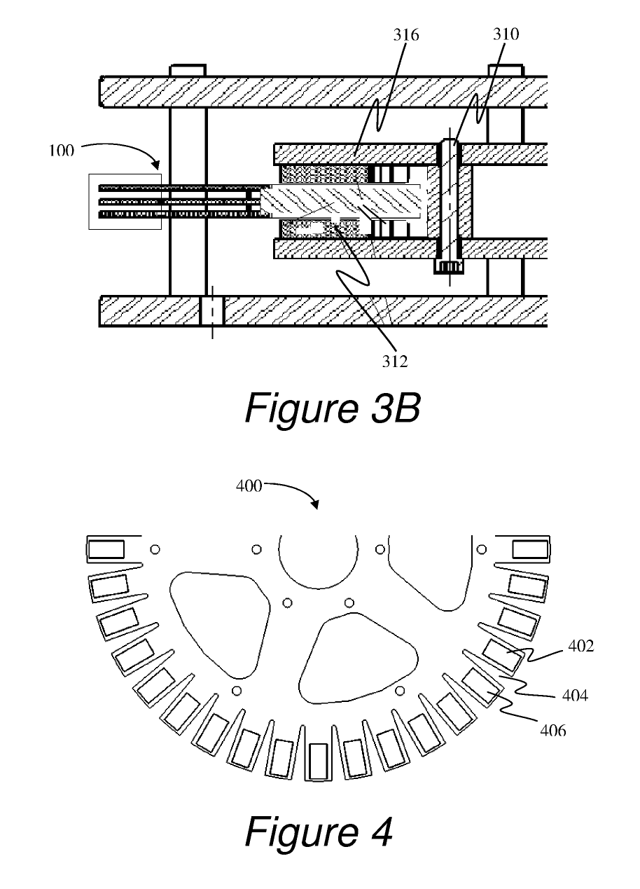

Referring now to FIG. 4, there is shown a bottom view of a rotor plate 400 usable in one embodiment of the present invention. As can be seen the magnets 402 and 406 are placed on the outer edge of the rotor plate 400. A flux linkage slot 404 bisects the placement of the magnets 402 and 406 to reduce flux linkage between the magnets, thereby generating a stronger magnetic field. In one embodiment, the magnets 402 and 406 are placed such that the poles of a first magnet 402 are opposite the poles of a second magnet 406 for generating alternating current.

All dimensions specified in this disclosure are by way of example only and are not intended to be limiting. Further, the proportions shown in the figures are not necessarily to scale. As will be understood by those with skill in the art with reference to this disclosure, the actual dimensions of any device or part of a device disclosed in this disclosure will be determined by its intended use.

As used in this disclosure, except where the context requires otherwise, the term “comprise” and variations of the term, such as “comprising”, “comprises” and “comprised” are not intended to exclude other additives, components, integers or steps.

Although the present invention has been discussed in considerable detail with reference to certain preferred embodiments, other embodiments are possible. Therefore, the scope of the appended claims should not be limited to the description of preferred embodiments contained in this disclosure.

What is claimed is:

1. A device for generating electricity comprising:
a) a turbine capable of spinning at variable revolutions per minute (RPM);
b) a configurable electric generator circuit connected to the turbine; and
c) a switching circuit connected to the generator circuit to configure the generator circuit as a function of the turbine RPM.

2. The device of claim 1, where the electric generator circuit can be configured to either a Wye-type generator circuit or a Delta-type generator circuit.

3. The device of claim 1, where the electric generator circuit and the switching circuit comprise a single printed circuit board.

4. The device of claim 2, where the switching circuit configures the generator circuit to a Wye-type generator circuit when the turbine is placed in a wind or water stream with a speed less than about 9.5 Km per hour.

5. The device of claim 2, where the switching circuit configures the generator circuit to a Delta-type generator circuit when the turbine is placed in a wind or water stream with a speed above about 9.5 Km per hour.

6. The device of claim 1, where the switching circuit comprises:
a) a state controller circuit connected to the generator circuit; and
b) a sense circuit electrically connected to the state controller circuit, and the generator circuit.

7. The device of claim 6, where the state controller circuit comprises one or more break-before-make field effect transistors.

8. The device of claim 6, where the sense circuit determines the turbine RPM and sends a signal to activate the state controller circuit when a pre-selected RPM is determined.

9. The device of claim 8, where the sense circuit comprises one or more voltage regulated gates.

10. A device for generating electricity comprising:
a) a turbine configured to rotate at variable rotation speeds;
b) means for generating electricity connected to the turbine; and
c) means for switching the state of the electricity generating means, as a function of the turbine speed.

11. The device of claim 10, where the switching means comprises:
a) a means for sensing the variable rotation speeds; and
b) a means for configuring the state of the electricity generating means.

12. The device of claim 10, where the sensing means comprises one or more voltage regulated gates.

13. The device of claim 10, where the configuring means comprises one or more break-before-make field effect transistors.

14. A method for generating electricity, comprising the steps of:
a) providing a multi-speed turbine;
b) providing a configurable electric generation circuit; and
c) configuring the generator circuit as a function of the turbine speed.
